(19) United States
(12) Patent Application Publication
(10) Pub. No.: US 2019/0347296 A1
(43) Pub. Date: Nov. 14, 2019

(54) METHOD OF RECOMMENDING AT LEAST ONE SKIN CARE PRODUCT TO A USER

(71) Applicant: Revieve Oy, Helsinki (FI)

(72) Inventors: Sampo Parkkinen, Vantaa (FI); Samuli Siivinen, Valencia (ES)

(21) Appl. No.: 16/408,635

(22) Filed: May 10, 2019

Related U.S. Application Data
(60) Provisional application No. 62/670,966, filed on May 14, 2018.

(51) Int. Cl. G06F 16/9032; G06F 16/9035; G06F 17/18

(52) U.S. Cl. CPC G06F 16/90324; A45D 2044/007; G06F 17/18; G06F 16/9035

(57) ABSTRACT

Disclosed is a method of recommending at least one skin care product to a user. The method may include retrieving, using a communication device, a plurality of User Generated Content (UGC) corresponding to a plurality of users from at least one data source. Further, the method may include analysing, using a processing device, the plurality of UGC. Further, the method may include determining, using the processing device, each of at least one skin care product and at least one feedback associated with the skin care product based on the analysing. Further, the method may include storing, using a storage device, the at least one feedback and an association between the at least one feedback and an indication of at least one skin care product.

### TECHNICAL FIELD

The aspects of the disclosed embodiments pertain in general to the field of product recommendation, and especially to proposing appropriate skin care product to a user.

### BACKGROUND

The skin care product market is huge across the world. Several brands offer a range of skin care products. Therefore, hundreds of different skin care products and other cosmetics are available in the market. The skin care products market size is projected to reach USD 196.67 billion by 2024, according to a report by Grand View Research, Inc.

However, it is challenging to select an appropriate skin care product since the selection depends on a personal profile of user (such as, man, women, age, skin condition, other preferences) etc.

Further, there is lack of availability of objective information related to the numerous skin care products. Some of the skin care products may have gone through testing such as medical testing. In such cases, the testing data may be available. However, for a lot of skin care products the testing data is not available. In such cases, the skin care products may go through testing and objective reports may be generated. However, it is challenging to collect a group of testers and conduct the various tests.

Therefore, in light of the foregoing discussion, there exists a need to overcome the aforementioned drawbacks.

### SUMMARY

According to an embodiment a method of recommending at least one skin care product to a user is provided, the method comprising:
retrieving a plurality of User Generated Content (UGC) corresponding to a plurality of users from at least one data source;
receiving information of at least one skin care product;
analysing the plurality of UGC to identify at least one feedback;
determining association between the at least one skin care product and the at least one feedback based on the analysis;
storing the at least one feedback and the determined association between the at least one feedback and the information of the at least one skin care product and using the stored information for making the recommendation of at least one skin care product.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 is an illustration of an online platform consistent with various embodiments of the present disclosure;

FIG. 2 is a flowchart for a method for recommending at least one skin care product to a user;

FIG. 3 is a flowchart for a method for obtaining information about at least one skin care product from at least one product database;

FIG. 4 is a flowchart for a method for crawling the Internet to obtain User Generated Content (UGC);

FIG. 5 is a flowchart for a method for obtaining probability related to the plurality of feedback;

FIG. 6 is a flowchart for a method for validating a commercial statement;

FIG. 7 provides example of user generated content in one information source; and

FIG. 8 is an illustration of a system according to one embodiment.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

According to some embodiments, the present disclosure provides an online platform for recommending at least one skin care product to a user. The online platform may be hosted on a centralized server, such as, for example, a cloud computing service. The centralized server may communicate with other network entities, such as, for example, a mobile device (such as a smartphone, a laptop, a tablet computer etc.), servers (such as servers hosting social networking websites, blogs, forums etc.), and a database over a communication network, such as, but not limited to, the Internet. Further, users of the online platform may include relevant parties such as, but not limited to, users, businesses, skin care product manufacturers, system administrators and so on. Accordingly, in some instances, electronic devices operated by the one or more relevant parties may be in communication with the platform.

A user, such as the one or more relevant parties, may access the online platform through a web based software application or browser. The web based software application may be embodied as, for example, but not be limited to, a website, a web application, a desktop application, and a mobile application.

According to an embodiment, the present disclosure provides a method for recommending at least one skin care product to a user. The method might comprise steps of retrieving a plurality of User Generated Content (UGC) corresponding to a plurality of users from at least one data source, receiving information of at least one skin care product; analyzing the plurality of UGC to identify at least one feedback; determining association between the at least one skin care product and the at least one feedback based on the analysis; storing the at least one feedback and the determined association between the at least one feedback and the information of the at least one skin care product, and using the stored information for making the recommendation of at least one skin care product.

Based on one embodiment the plurality of UGC may include one or more of a social media post (such as a post on a social networking site), a blog entry, a comment and a forum discussion. Further, the retrieving may include crawling the Internet, specifically, the search engines, the social network sites, the blogs, the online forums etc. to obtain UGC related to the at least one skin care product. For example (Example 1), a UGC may be a comment posted by a user in an online forum discussion—“I used Product A and was very happy with it. I used to have dry skin but after using it every day for two weeks moisture level of skin was back in normal”. Further information of at least one skin care product might be received from an information source such as search engine, product catalogue, blog, web site.

Further the analysing may include employing Natural Language Processing (NLP) for the UGC. Accordingly, the text-based entries (in the UGC) related to skin care product(s) may be analysed using NLP algorithms. This may include finding a text entry which definitely talks about certain product and conveys its effect. Accordingly, the NLP algorithms may determine that the comment in the example 1 is related to a “product A”. Further, the NLP algorithms may determine that the comment in the example 1 indicates that the “product A” had an effect of increasing the moisture level of skin. The UGC can be used to identify at least one feedback related to a product. Based on embodiment the at least one feedback may include a usage time. Accordingly, for the comment in the example 1, the at least one feedback may indicate a usage time of two weeks of the “product A”. Further, the at least one feedback may include at least one user experience associated with usage of the at least one skin care product. Accordingly, for the comment in the example 1, the at least one feedback may indicate that the “product A” usage resulted in positive effect.

Further association between the at least one skin care product and the at least one feedback is determined based on analysis. As an example if feedback is given in context of product review of a skin care product the feedback can be associated with the skin care product.

Further the at least one feedback and determined association between the at least one feedback and the information of the at least one skin care product may be stored. The information related to the at least one skin care product may include one or more of a Universal Product Code (UPC), European Article Number (EAN) and a barcode. Further, the at least one feedback and an association between the at least one feedback and the information of at least one skin care product may be stored in a database such as the database of the online platform. Further according to embodiment the stored information is used to make a recommendation of at least one skin care product. For example if a stored information comprises a feedback that the skin care product is good for skin when used in humid environment this information is added to a skin care product information. A person searching for a product to be used in humid environment would be recommended to use said product.

Further, according to some embodiments, a method for obtaining information about at least one skin care product from at least one product database is also provided. For example, the at least one product database may include Open Knowledge Foundation's Open Product Data, Scandit's UPC lookup, MINTEL Global New Products Database (GNPD).

Accordingly, the method may include a step of retrieving, using the storage device, the indication of at least one skin care product. Further, the indication of at least one skin care product may be provided by a user.

Further, the method may include a step of transmitting, using a communication device, a query to the at least one product database. Further, the query may include the indication of the at least one skin care product.

Further, the method may include a step of receiving, using the communication device, a query response including product information corresponding to the at least one skin care product from the at least one product database. For example, the query response may include product information such as, but not limited to, product name, brand, color, rating, price, purchase URL, and availability.

Further, the method may include a step of storing, using the communication device, each of the indication of the at least one skin care product, the product information in association with the indication of the at least one skin care product. Further, each of the indication of the at least one skin care product and the product information in association with the indication of the at least one skin care product may be stored in a database such as the database of the online platform.

Further, according to some embodiments, a method for crawling the Internet to obtain UGC is also provided. Accordingly, the method may include a step of transmitting, using the communication device, a web query including the indication of the at least one skin care product to at least one search engine. Further, the indication may include at least one name associated with the at least one skin care product. For example, the at least one search engine may include web search engines such as, but not limited to, Google™, Bing™, Baidu™ and Yahoo™. Further, the at least one search engine may include special sites such as, but not limited to, Bing Shopping™, Google Shopping™, Kelkoo™, MySimon™, PriceGrabber™, PriceRunner™, PriceSCAN™, Pronto.com™.

Further, the method may include a step of receiving, using the communication device, at least one webpage from the search engine in response to the web query.

Further, the method may include a step of parsing, using the processing device, the at least one webpage to extract the plurality of UGC. For example, statements like the comment in example 1 may be extracted from a forum.

In some embodiments, the at least one feedback may include a plurality of feedback. Further, the plurality of feedback may be associated with a plurality of data sources including the plurality of UGC.

Additionally, the method may include a step of determining, using the processing device, a number associated with the plurality of feedback. For example, the plurality of feedback may include statements about the “product A”. According to example 1, a user may post a comment in an online forum discussion—“I used Product A and was very happy with it. I used to have dry skin but after using it every day for two weeks moisture level of skin was back in normal”. Further, similar statements may be obtained. For example (example 2), another user may post on a social media post—“Product A was good. After 14 days of usage my skin was not dry any more”. Similarly, more statements may be obtained and analyzed. Accordingly, based on these statements, a “2 week” (or a “14 days”) number may be determined. Additionally, in some embodiments, the number associated with the plurality of feedback may represent the number of different users who provided an identical and/or similar feedback on a skin care product.

Further, the method may include a step of determining, using the processing device, a probability associated with the at least one feedback corresponding to the at least one skin care product based on the number determined. For example, the probability that the moisture level will be normalized after using the “product A” for 14 days may be determined. This may include obtaining all statements which indicate any number of days in which the moisture level got normalized for the various users after using the “product A”. Accordingly, the probability that the moisture level will be normalized after using the “product A” for 14 days may be calculated by dividing the total number of statements which indicate that the moisture level got normalized after using the “product A” for 14 days by the total number of statements indicating any number of days in which the moisture level got normalized for the various users after using the “product A”. Alternatively, and/or additionally, in some embodiments, the probability may be determined based on the number of identical and/or similar feedback with regard to a skincare product. For example, the probability may be determined based on a ratio of the number of identical and/or similar feedback with regard to a skin care product to the total number of feedback with regard to the skincare product (irrespective of the nature of feedback).

In some embodiments, the method may further include a step of comparing, using the processing device, the probability with a predetermined threshold. Further, the storing of the at least one feedback and the association between the at least one feedback and the indication of at least one skin care product may be based on the probability exceeding the predetermined threshold. For example, the predetermined threshold may be 60%. Accordingly, the at least one feedback may be stored only if the corresponding is 60% or above. This will help in storing only verified user statements.

In alternate embodiments, if 5 statements indicate that the moisture level got normalized after using the after using the “product A” for 14 days and 3 statements indicate that the moisture level got normalized after using the after using the “product A” for 10 days, then a weighted average may be used to obtain a possible number of days required to normalize the moisture level. For example, equation 1 below may be used to calculate the weighted average.

The weighted average=(N1×S1+N2×S2)/(S1+S2) [1]

wherein, Ni—Number of days, Si—Number of statements

The weighted average=(14×5+10×3)/(5+3);

The weighted average=(70+30)/(8)=100/8=12.5

Accordingly, the possible number of days required to normalize the moisture level is 12. 5 days.

According to some embodiments, a method for validating a commercial statement is also provided. The commercial statement may be a product claim made by a manufacturer. The method may include a step of retrieving, using the communication device, at least one product claim corresponding to the at least one skin care product from the at least one data source. In some embodiments, the at least one product claim may be comprised in at least one advertisement associated with the at least one skin care product. For example, the at least one advertisement associated with the at least one skin care product may say “Just use the product for 7 days to normalize the moisture level of your skin”. The advertisement may be a text advertisement, an audio advertisement and a video advertisement. For the audio advertisement, a speech-to-text application may be used to obtain the corresponding product claim in text format. Similarly, for the video advertisement, a speech-to-text application and/or an image processing application may be used to obtain the corresponding product claim in text format.

Further, the method may include a step of comparing, using the processing device, the at least one product claim with the at least one feedback. Further, the method may include a step of validating, using the processing device, the at least one product claim based on the comparing.

For example, if a product claim says that the corresponding product helps to cure dry skin after 7 days of usage. However, the user feedback may indicate the effect after at least 14 days of usage. The comparison and validation may indicate that the product claim is likely to be wrong. This information may be provided to the potential customers.

On the other hand, if the product claim says that the corresponding product helps to cure dry skin after 14 days of usage, then the product claim may be validated to be true.

In further embodiments, the method may include a step of generating, using the processing device, at least one trust score associated with at least one company associated with the at least one skin care product. Further, the at least one trust score may be based on the validating. The trust score may be used to differentiate product providers as honest and dishonest.

According to some aspects, an embodiment of the present disclosure is a method for enriching product information by adding more information, tags, summaries, parameters to an existing database entry of a product. The method may include selecting a product. A basic information of the product may be obtained from related product databases by using the product title, UPC/EAN codes etc. Further, the product information may also be obtained from the user generated content (UGC). This may include crawling the internet to obtain information from blog entries, comments, and discussions in forums. Further, the method may include analyzing the information using natural language processing (NLP) algorithms to find product effects. For example, NPL algorithms may be used to find statements which are related to changing from one condition to another condition (such as dry skin to moisture skin). Further, NPL algorithms may be used to find statements related to usage time (such as, used that for two weeks, used that for half of month, used that for a few days etc.). Thereafter, based on the information obtained by the NLP algorithms, the product information may be enriched by adding the product effects.

As an additional example an automated system is provided. The system comprises of a web crawler browsing through User Generated Content based on a skincare product UPC-code or product name, subsequently leveraging natural language processing to identify key phrases, attributes and sentiments in said UGC. Using said system to assess the objective functionality and suitability of the particular skincare product UPC through a probabilistic method against a skincare concerns highlighted by an individual in writing, assessed from a computer-vision analysis of the individuals face or through automatically detecting the individuals environmental considerations impacting the use and suitability of skincare products.

Further based on embodiments UGC can be used for creating recommendations, updating recommendations and analyzing validity of recommendations. The UGC can be further used to validating product claim/recommendation of the manufacturer of a product.

Embodiments of the present disclosure substantially eliminate or at least partially address the aforementioned problems in the prior art, thereby providing validated and objective user feedback for the skin care products. Further, the present disclosure validates product claims in various advertisements related to the skin care products. This allows customers to purchase the skin care products that suit their exact requirements.

### DETAILED DESCRIPTION OF THE DRAWINGS

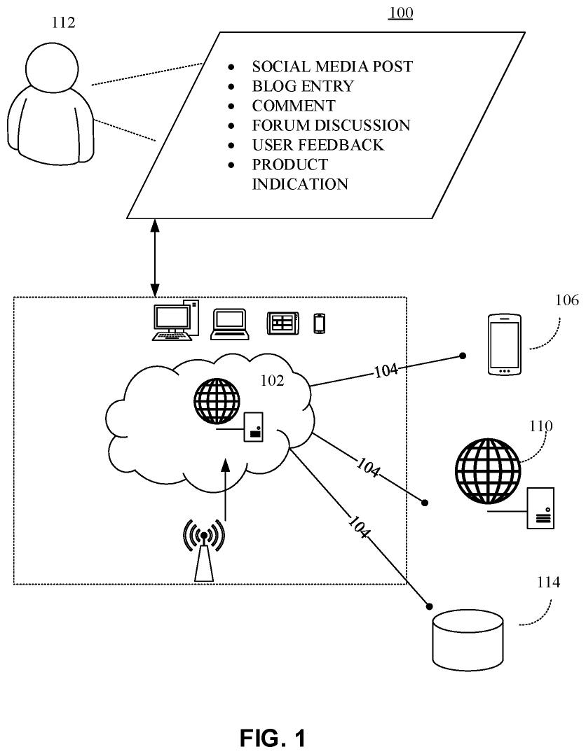

FIG. 1 is an illustration of an online platform 100 consistent with various embodiments of the present disclosure. By way of non-limiting example, the online platform 100 for recommending at least one skin care product to a user may be hosted on a centralized server 102, such as, for example, a cloud computing service. The centralized server 102 may communicate with other network entities, such as, for example, a mobile device 106, servers 110, a database 114, over a communication network 104, such as, but not limited to, the Internet. Further, users of the online platform 100 may include relevant parties such as, but not limited to, users, businesses, skin care product manufacturers, system administrators and so on. Accordingly, in some instances, electronic devices operated by the one or more relevant parties may be in communication with the platform. A user 112, such as the one or more relevant parties, may access online platform 100 through a web based software application or browser.

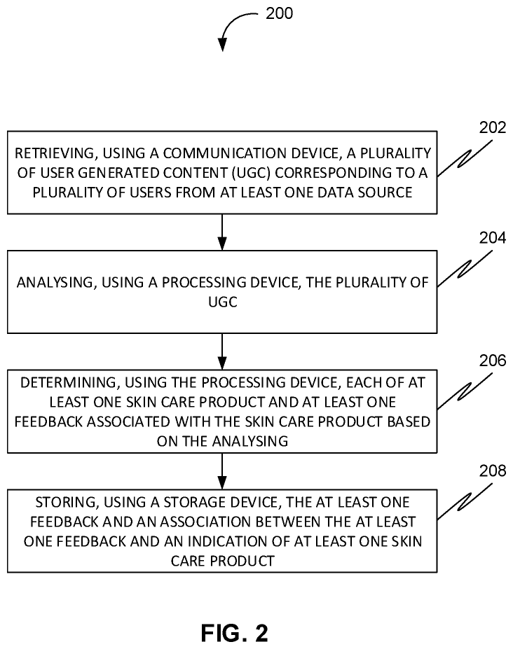

FIG. 2 is a flowchart for a method 200 for recommending at least one skin care product to a user. At 202, the method 200 includes retrieving, using a communication device, a plurality of User Generated Content (UGC) corresponding to a plurality of users from at least one data source.

Further, at 204, the method 200 includes analysing, using a processing device, the plurality of UGC. Further, the analysing may include employing Natural Language Processing (NLP) for the UGC.

Further, at 206, the method 200 includes determining, using the processing device, each of at least one skin care product and at least one feedback associated with the skin care product based on the analysing.

Further, at 208, the method 200 includes storing, using a storage device, the at least one feedback and an association between the at least one feedback and an indication of at least one skin care product.

In some embodiments, the method 200 may further include storing, using the storage device, the indication of the at least one skin care product.

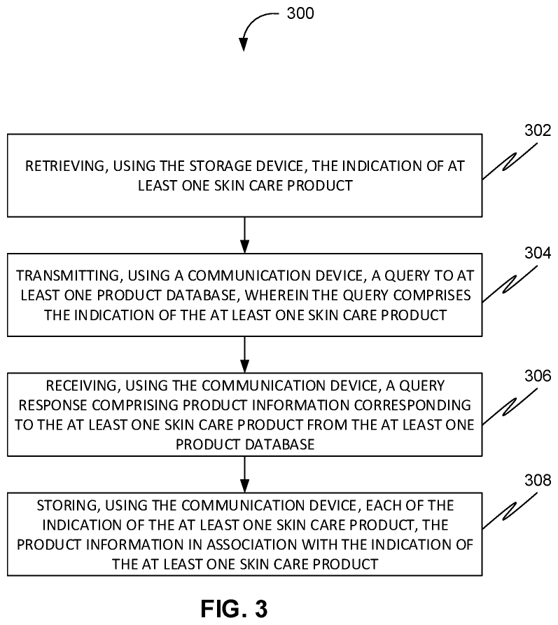

FIG. 3 is a flowchart for a method 300 for obtaining information about at least one skin care product from at least one product database.

At 302, the method 300 includes retrieving, using the storage device, the indication of at least one skin care product. Further, the indication of at least one skin care product may be provided by a user.

Further, at 304, the method 300 includes transmitting, using a communication device, a query to the at least one product database.

Further, the query may include the indication of the at least one skin care product.

Further, at 306, the method 300 includes receiving, using the communication device, a query response including product information corresponding to the at least one skin care product from the at least one product database.

Further, at 308, the method 300 may include storing, using the communication device, each of the indication of the at least one skin care product, the product information in association with the indication of the at least one skin care product.

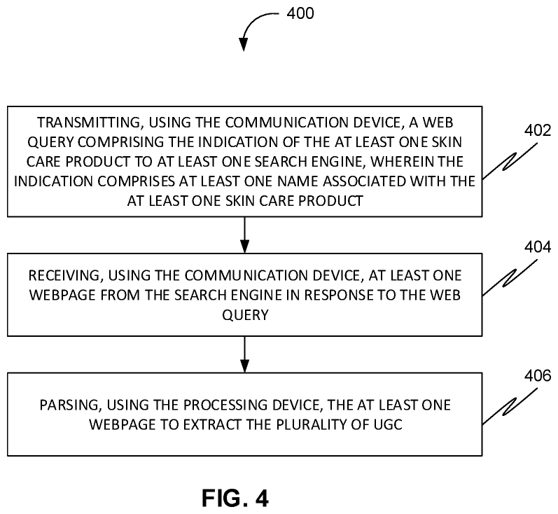

FIG. 4 is a flowchart for a method 400 for crawling the Internet to obtain UGC. At 402, the method 400 includes transmitting, using the communication device, a web query including the indication of the at least one skin care product to at least one search engine. Further, the indication may include at least one name associated with the at least one skin care product.

Further, at 404, the method 400 includes receiving, using the communication device, at least one webpage from the search engine in response to the web query.

Further, at 406, the method 400 includes parsing, using the processing device, the at least one webpage to extract the plurality of UGC.

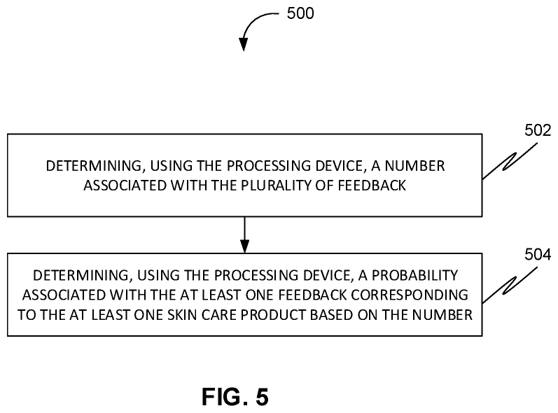

In some embodiments, the at least one feedback may include a plurality of feedback. FIG. 5 is a flowchart for a method 500 for obtaining probability related to the plurality of feedback. The plurality of feedback may be associated with a plurality of data sources including the plurality of UGC.

At 502, the method 500 includes determining, using the processing device, a number associated with the plurality of feedback.

Further, at 504, the method 500 includes determining, using the processing device, a probability associated with the at least one feedback corresponding to the at least one skin care product based on the number determined at 502.

In some embodiments, the method 500 may further include comparing, using the processing device, the probability with a predetermined threshold. Further, the storing of the at least one feedback and the association between the at least one feedback and the indication of at least one skin care product may be based on the probability exceeding the predetermined threshold.

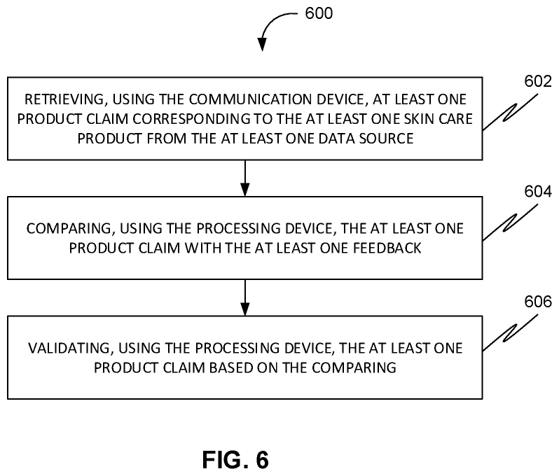

FIG. 6 is a flowchart for a method 600 for validating a commercial statement. The commercial statement may be a product claim made by a manufacturer. At 602, the method 600 includes retrieving, using the communication device, at least one product claim corresponding to the at least one skin care product from the at least one data source.

Further, at 604, the method 600 includes comparing, using the processing device, the at least one product claim with the at least one feedback. Further, at 606, the method 600 may include validating, using the processing device, the at least one product claim based on the comparing.

In further embodiments, the method 600 may include generating, using the processing device, at least one trust score associated with at least one company associated with the at least one skin care product. Further, the at least one trust score may be based on the validating (at 606).

In some embodiments, the methods 200-600 may be executed by the online platform 100.

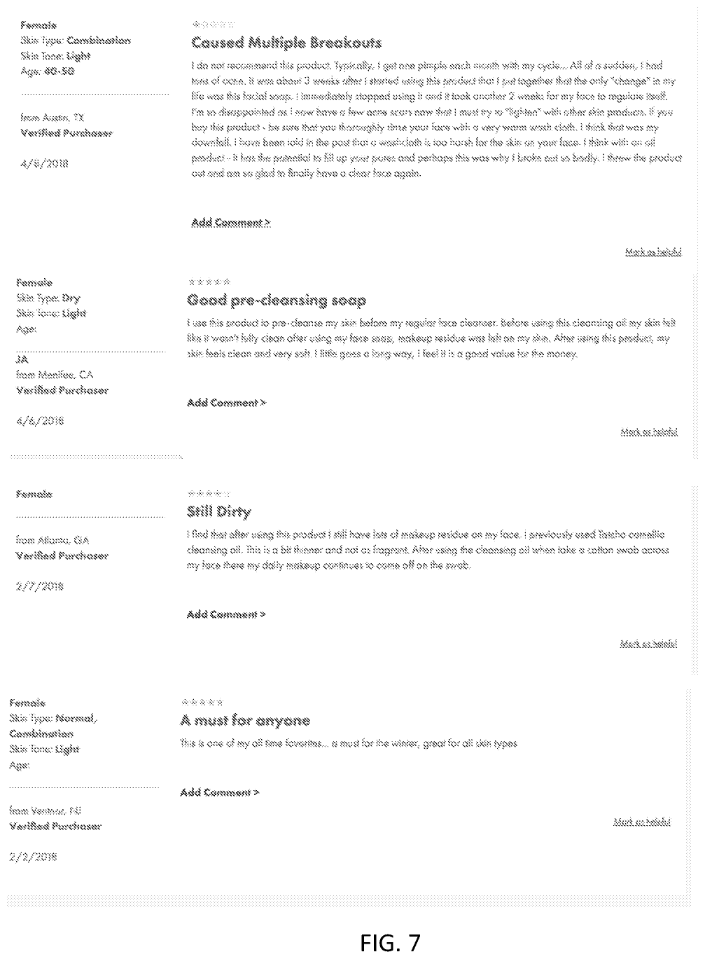

FIG. 7 provides example of user generated content (UGC) from consumers. In the FIG. 4 different user generated content are presented for a product XYZ having UPC code of 12345. The content is rendered in a user interface of at least one data source (blog in present figure).

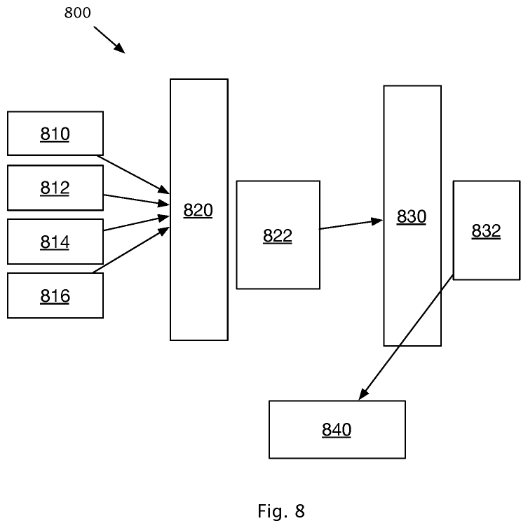

FIG. 8 is an illustration of a system 800. The UGC 810, 812, 814, 816 originates from a plurality of users and can be for example the content of FIG. 7. The UGC 810, 812, 814, 816 can be in a data source such as in a web page. The content is retrieved by natural language processing (NLP) engine 820. The content is analysed with the engine to identify at least one feedback. The feedbacks are stored in database 822. As an example UGC can comprise feedbacks of product having a positive or negative impact. Some of the feedbacks might be neutral or such which can not be classified. Association between at least one skin product (for example the product XYZ) and feedback is formed in the NLP engine 820. Association can be for example that out 512 positive 208 mentions eyebag reduction and 271 negative feedbacks 102 mentions eyebag reduction. The associations and feedback is further analysed/processed in an digital beauty artificial intelligence module 830 to determine weighting for updating information related to the skin product XYZ. For example if the manufacture provided information of the at least one skin care product was “Reduced Eyebags” with weighting of 10. After the further processing the probability that the product is good for eyebag reduction is increased for example to 14.58 for the claim of reducing eyebag. This is further used by digital beauty advisor module 840 to recommend product.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

1. A method of recommending at least one skin care product to a user, the method comprising:
retrieving a plurality of User Generated Content (UGC) corresponding to a plurality of users from at least one data source;
receiving information of at least one skin care product;
analysing the plurality of UGC to identify at least one feedback;
determining association between the at least one skin care product and the at least one feedback based on the analysis;
storing the at least one feedback and the determined association between the at least one feedback and the information of the at least one skin care product and
using the stored information for making the recommendation of at least one skin care product.

2. The method of claim 1, wherein the plurality of UGC comprises at least one of a social media post, a blog entry, a comment and a forum discussion.

3. The method according to claim 1, wherein the indication of the at least one skin care product comprises at least one of a Universal Product Code (UPC), European Article Number (EAN) and a barcode.

4. The method according to claim 1, wherein the at least one feedback comprises a plurality of feedbacks, the method further comprising:
determining a number associated with the plurality of feedback; and
determining a probability associated with the at least one feedback corresponding to the at least one skin care product based on the number.

5. The method according to claim 1, wherein the plurality of feedbacks is associated with a plurality of data sources comprising the plurality of UGC.

6. The method according to claim 4 further comprising comparing the determined probability with a predetermined threshold, wherein the storing of the at least one feedback and the association between the at least one feedback and the indication of at least one skin care product is based on the probability exceeding the predetermined threshold.
